(19) United States
(12) Patent Application Publication
(10) Pub. No.: US 2025/0099914 A1
(43) Pub. Date: Mar. 27, 2025

(54) CARBON NEUTRAL LANDFILL SOLUTIONS

(71) Applicant: Exotex, Inc., Houston, TX (US)

(72) Inventor: Michael J. Parrella, Katy, TX (US)

(21) Appl. No.: 18/728,170

(22) PCT Filed: Jan. 11, 2023
(86) PCT No.: PCT/US2023/010573

§ 371 Date: Jul. 11, 2024

Related U.S. Application Data
(60) Provisional application No. 63/298,514, filed on Jan. 11, 2022.

(51) Int. Cl. B01D 53/73; B01D 53/72; B09B 1/00; C05F 7/00; C05F 9/02

(52) U.S. Cl. CPC B01D 53/73; B01D 53/72; B09B 1/006; C05F 7/00; C05F 9/02; B01D 2256/245; B01D 2258/05

(57) ABSTRACT

A system and method for recovering and utilizing landfill gas for electricity generation is provided, the system comprising: a landfill, biogas collection wells configured to collect biogas in the landfill, leachate collection wells configured to collect leachate in the landfill, and carbon dioxide injection wells configured to inject carbon dioxide into the landfill. The wells are arranged in a stratification in the landfill with the one or more biogas collection wells are arranged on top of the leachate collection wells, and the leachate collection wells are arranged on top of the carbon dioxide injection wells, and the carbon dioxide injection wells being arranged at the bottom. Methane recovered from the landfill biogas is used as a fuel source in the generation of electricity and the carbon dioxide exhaust from electricity generation is injected into the landfill to enhance the extraction of the biogas.

### CROSS-REFERENCE TO RELATED APPLICATIONS

The present application claims the benefit of U.S. Provisional Patent Application No. 63/298,514 filed Jan. 11, 2022, which is hereby incorporated by reference in its entirety.

### FIELD OF THE INVENTION

The present application relates to a method and system for recovering methane and leachate from landfills and other sources of municipal solid waste.

### BACKGROUND OF THE DISCLOSURE

Within landfills where municipal waste is deposited, gas accumulates as a byproduct of the decomposition of the waste. The landfill gas, comprising methane and carbon dioxide, can be extracted from the landfill and used as a source of energy. In prior art systems, landfill gas collection systems utilize gas collection wells to collect and transport the gas for use in energy production by burning the gas to generate heat which generates electricity, or the gas is flared where the utilization of the gas is less feasible economically. The electricity generated from landfill gas can be provided to a grid or can be used on site as a replacement for other fuel sources. As the rate of gas production varies, the capacity of the gas utilization plant should be adaptable to changing gas extraction rates to avoid flaring of gas. The cost for improving the quality of landfill gas to a quality level of natural gas can be high, as landfill gas may also include other gases, such as oxygen or nitrogen. Landfill gas may also be used for heat production in boilers using burners that are adapted to the relatively low methane content compared with natural gas. There are also economic challenges associated with storage of landfill gas for long periods of time.

Additionally, landfill gas can be a significant contributor to greenhouse gas emissions. Methane is a significant component of landfill gas, and is a more potent greenhouse gas than carbon dioxide, as methane is 28 to 36 times more effective than carbon dioxide at trapping heat in the atmosphere. Methane capture systems can be used to reduce some of the greenhouse gas emissions, but problems with current methane landfill collection systems, which convert methane to carbon dioxide, include a need for flaring gas due to poor economics, no local use for the heat or electricity, no consistency in the biogas flow, no consistency in the biogas makeup, and low methane content.

Also present within landfills is leachate, which is contaminated liquid that is generated from water percolating through a solid waste disposal site, accumulating contaminants, and moving into subsurface areas, such as rainwater that filters through waste in a landfill that contacts the waste and draws out chemicals or other constituents of the landfill waste.

### SUMMARY OF THE DISCLOSURE

The present application relates to methods and systems to harvest methane, leachate and/or waste from a landfill by injecting carbon dioxide. The methods and systems of the present application also allow for the use of the methane and/or waste to generate electricity; the use of the electricity to power the landfill and greenhouses; and the use of carbon dioxide and nitrogen from the electricity generation exhaust stream to stimulate crop growth. The systems and methods described herein work for operating active or closed landfills, and the waste to energy option can be used to reclaim the land.

The present application provides a system that eliminates methane emissions without emitting carbon dioxide in a landfill, reclaims land by processing waste, collects leachate and use it for sludge digesting, generates electricity and food without greenhouse gas emissions by using methane and/or solid waste from a landfill, uses carbon dioxide to harvest the methane and leachate, and uses generated energy to run the landfill and to grow food or other plants.

In accordance with a first aspect of the present application, a system is provided, the system comprising: a waste repository comprising waste therein; one or more biogas collection wells configured to collect biogas in the waste repository, the biogas may include methane; one or more leachate collection wells configured to collect leachate in the waste repository, the leachate may include water; and one or more carbon dioxide injection wells configured to inject carbon dioxide into the waste repository. The one or more biogas collection wells, the one or more leachate collection wells, and the one or more carbon dioxide injection wells are arranged in a stratification in the waste repository where the one or more biogas collection wells are arranged on top of the one or more leachate collection wells, and the one or more leachate collection wells are arranged on top of the one or more carbon dioxide injection wells. The waste repository of the system may be a landfill, or other waste or refuse storage environments.

In accordance with various implementations of the system of the first aspect of the present application, the system further comprises one or more carbon dioxide pumps configured to pump the carbon dioxide into the one or more carbon dioxide injection wells, and the carbon dioxide injected into the landfill is pressurized and configured to push the biogas in the landfill towards an upper stratum of the landfill. The system may further comprise one or more biogas pumps configured to pull the biogas into the one or more biogas collection wells. The system may still further comprise one or more leachate pumps configured to pull the leachate into the one or more leachate collection wells. Each of the one or more biogas collection wells, the one or more leachate collection wells, and the one or more carbon dioxide injection wells may include porous pipes within the landfill, the porous pipes comprising a pipe with pores through pipe walls to allow a gas or liquid to pass through the pipe walls into or out of the pipe. The porous pipes of the one or more biogas collection wells, the one or more leachate collection wells, and the one or more carbon dioxide injection wells are arranged horizontally across the landfill.

In accordance with additional or alternative implementations of the system of the first aspect of the present application, the system may further comprise a first gas separator configured to: receive the biogas collected from the landfill; separate component gases of the biogas; and output separated gases, including separated methane. The system may further include an external combustion system configured to receive and burn the separated methane to provide thermal energy for powering one or more turbines of an electricity generating system. The external combustion system is further configured to provide heated exhaust gas to the one or more turbines. The electricity generation system may be configured to provide electricity for powering electrical components of the system, and/or to provide electricity to a grid or an external facility consuming the electricity. The system may further comprise a second gas separator configured to receive turbine exhaust gases and to separate carbon dioxide from the turbine exhaust gases and provide at least a portion of the separated carbon dioxide to the one or more carbon dioxide injection wells configured to inject the separated carbon dioxide into the landfill. The electricity generation system may be further configured to provide electricity to the crop or plant growth system, and the second gas separator may be configured to: separate oxygen gas, carbon dioxide gas, and nitrogen gas from the turbine exhaust gases and other gases provided to the second gas separator; and provide at least a portion of the separated carbon dioxide gas and separated nitrogen gas to the crop or plant growth system for stimulation of crop or plant growth. The leachate comprises microorganisms for digesting the sludge in the sludge digester, and where sludge digester is configured to output a fertilizing material for providing to the crop or plant growth system and output gases to the first gas separator. The external combustion system further may include a furnace or burner configured to combust biomass waste from the landfill and to provide thermal energy from biomass waste combustion to the one or more turbines for heating fluid to generate steam for the one or more turbines. The biomass waste combustion further may provide heated waste exhaust gases to the one or more turbines for heating fluid to generate steam for the one or more turbines.

In accordance with a second aspect of the present application, a method for processing gases in a landfill having waste therein is provided. The method comprises collecting biogas in the landfill by one or more biogas collection wells, the biogas comprising methane; collecting leachate in the landfill by one or more leachate collection wells, the leachate comprising water; and injecting carbon dioxide into the landfill by one or more carbon dioxide injection wells. The one or more biogas collection wells, the one or more leachate collection wells, and the one or more carbon dioxide injection wells are arranged in a stratification in the landfill where the one or more biogas collection wells are arranged on top of the one or more leachate collection wells, and the one or more leachate collection wells are arranged on top of the one or more carbon dioxide injection wells.

In accordance with various implementations of the system of the first aspect of the present application, the method may comprise pumping, by one or more carbon dioxide pumps, carbon dioxide into the one or more carbon dioxide injection wells, and injecting carbon dioxide into the landfill by one or more carbon dioxide injection may include injecting pressurized carbon dioxide into the landfill, the pressurized carbon dioxide configured to push the biogas in the landfill towards an upper stratum of the landfill. The method may further comprise pulling the biogas into the one or more biogas collection wells by one or more biogas pumps. The method may further include pulling the leachate into the one or more leachate collection wells by one or more leachate pumps. Each of the one or more biogas collection wells, the one or more leachate collection wells, and the one or more carbon dioxide injection wells may include porous pipes within the landfill, the porous pipes comprising a pipe with pores through pipe walls to allow a gas or liquid to pass through the pipe walls into or out of the pipe. The porous pipes of the one or more biogas collection wells, the one or more leachate collection wells, and the one or more carbon dioxide injection wells can be arranged horizontally across the landfill.

In accordance with additional or alternative implementations of the system of the first aspect of the present application, the method may further comprise receiving, by a first gas separator, the biogas collected from the landfill; separating, by the first gas separator, component gases of the biogas; and outputting, by the first gas separator, separated gases, including separated methane. The method may still further comprise burning the separated methane in an external combustion system, and providing thermal energy from the external combustion system for powering one or more turbines of an electricity generating system. The method may include providing heated exhaust gas from the external combustion system to the one or more turbines. The electricity generation system is configured to provide electricity for powering electrical components of the system and/or provide electricity to a grid or an external facility consuming the electricity. The method may further comprise: receiving, by a second gas separator, turbine exhaust gases; separating, by the second gas separator, carbon dioxide from the turbine exhaust gases; and providing, by the second gas separator, at least a portion of the separated carbon dioxide to the one or more carbon dioxide injection wells injecting the separated carbon dioxide into the landfill. The method may still further comprise, include: providing electricity from the electricity generation system to a crop or plant growth system. The method may comprise further: separating, by the second gas separator, oxygen gas, carbon dioxide gas, and nitrogen gas from the turbine exhaust gases and other gases provided to the second gas separator; and providing, from the second gas separator, at least a portion of the separated carbon dioxide gas and separated nitrogen gas to the crop or plant growth system for stimulation of crop or plant growth. In additional embodiments of the method, the method further comprise providing the leachate collected in the landfill from the one or more leachate collection wells and sludge from a wastewater treatment system to a sludge digester; digesting the sludge by the sludge digester, and outputting a fertilizing material for providing to the crop or plant growth system and outputting gases to the first gas separator, from the sludge digester. Additional or alternative embodiments of the method of the second aspect of the present application may further comprise: providing biomass waste from the landfill to the external combustion system; burning the biomass waste by a furnace or burner of the external combustion system; and providing thermal energy from biomass waste combustion to the one or more turbines for heating fluid to generate steam for the one or more turbines, and may further include providing heated waste exhaust gases from the biomass waste combustion to the one or more turbines for heating fluid to generate steam for the one or more turbines.

### BRIEF DESCRIPTION OF THE FIGURES

FIG. 1a shows a cross-sectional view of a landfill in accordance with the present application;

FIG. 1b shows a cross-sectional view of the stratification of methane, leachate, and carbon dioxide in the landfill of FIG. 1a;

FIGS. 2a and 2b show top views of landfills according to the present application;

FIG. 3a shows a diagram of a system for converting methane and leachate into energy in accordance with an embodiment of the present application;

FIG. 3b shows a diagram of a system for converting waste, methane, and leachate into energy in accordance with an embodiment of the present application;

FIG. 3c shows a diagram of a system for converting waste into energy in accordance with an embodiment of the present application;

FIG. 4a shows a diagram of methane processing flow in accordance with an embodiment of the present application;

FIG. 4b shows a diagram of methane and waste processing flow in accordance with an embodiment of the present application; and

FIG. 4c shows a diagram of waste processing flow in accordance with an embodiment of the present application.

### DETAILED DESCRIPTION OF THE FIGURES

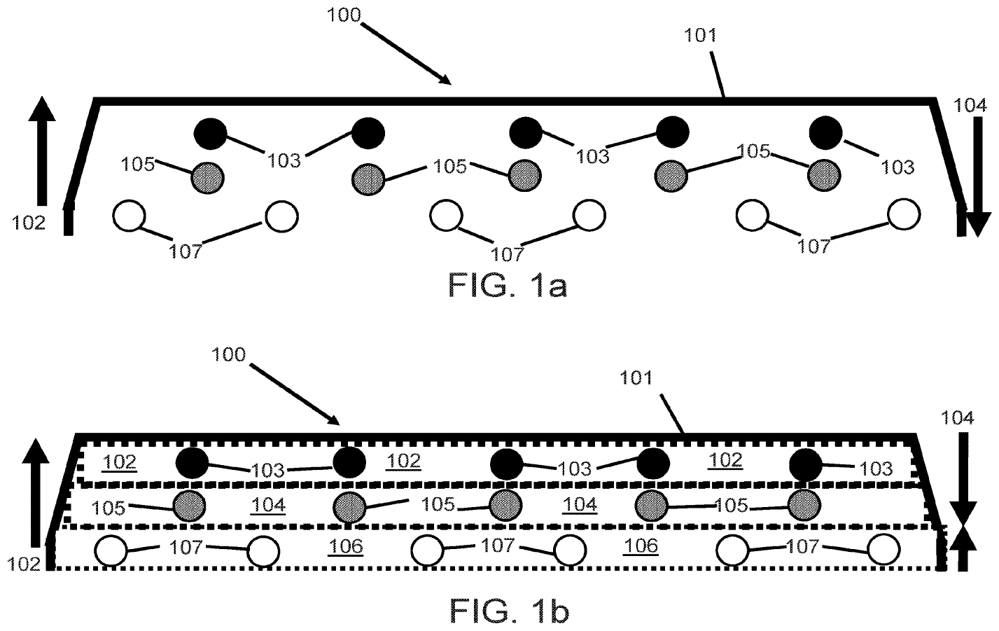

The landfill processing systems and processes of the present application will now be described with reference made to FIGS. 1a to 4c.

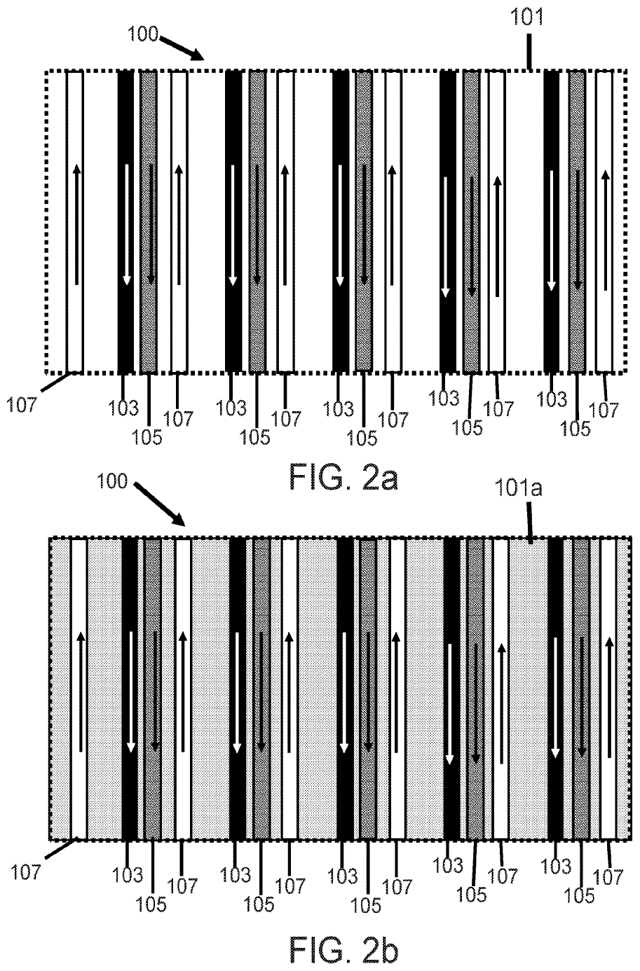

FIG. 1a shows a side view of a landfill 100 in accordance with the present application. FIG. 1b shows a side view of the stratification of the landfill of FIG. 1a. FIGS. 2a and 2b show top views of a landfill 100 according to the present application. The landfill 100 is provided with biogas collection wells 103 for the collection of biogas 102 from the landfill 100, the biogas 102 primarily comprising methane, leachate collection wells 105 for the collection of leachate 104 from the landfill 100, and carbon dioxide wells 107 for the injection of carbon dioxide 106 into the landfill 100.

In the landfill 100, carbon dioxide 106 is pressurized and injected into the landfill 100 through horizontal carbon dioxide injection wells 107. The carbon dioxide injection wells 107 can be arranged at a base of the landfill 100. Carbon dioxide has a density of 1.56 grams per cubic centimeter, and is denser than methane, which has a density of 0.00065 grams per cubic centimeter. The leachate 104, which primarily consists of water with a density of one gram per cubic centimeter, is denser than the biogas 102 primarily comprising methane.

The injected carbon dioxide 106 is pressurized, which results in an upward pushing of the biogas 102 in the landfill 100. The biogas 102 primarily comprising methane is pushed towards and collects at a top stratum of the landfill 100, and due to the lower density of the biogas 102, it remains at the top stratum of the landfill 100 for recovery by the biogas recovery wells 103. The leachate 104 moves to and collects in the middle of the landfill 100, in a layer between the biogas 102 and carbon dioxide 106. This stratification allows the system to use the carbon dioxide injection wells 107 to more effectively harvest the biogas 102 and leachate 104.

The biogas 102 is collected by low pressurized biogas collection wells 103 at the top of the landfill 100. Pumps (not shown) outside of the landfill 100 are configured to create a suction pull in the pipes of the wells 103, 105, drawing the biogas 102 and leachate 104 into the pipes for delivery outside of the landfill 100. Thus, the recovery of biogas 102 is enhanced and compounded by the simultaneous pushing of the biogas 102 within the landfill 100 by the injection of the pressurized carbon dioxide 106 that is heavier than the biogas 102, and the pulling of the biogas 102 out of the landfill 100 by the external pump. The injection of the pressurized carbon dioxide 106 and the pumping out of the biogas 102 may be synchronously to constructively increase their effects and the recovery of biogas 102. The leachate 104 is similarly collected by horizontal leachate collection wells 105 in the landfill 100 and pumped out of the landfill 100. The landfill 100 is sealed by a cover 101 so no gas escapes. The landfill 100 may also be covered by a layer of asphalt 101a, as shown in FIG. 2b.

The wells 103, 105, 107 can be made with porous pipe systems previously discussed in applicant's prior applications, including U.S. patent application Ser. No. 15/552,868 filed Aug. 23, 2017, which is hereby incorporated by reference in its entirety. Although the present application is not limited to a particular type or material of porous pipe, the porous pipes described herein can be fibrous porous pipes as described in the aforementioned prior application, where the amount of porosity can determined by the weave, knit, braid or spin, and the size of the flow paths created. The pipe may be porous substantially across its entire surface area, flow of fluids through the pipe is increased. Using a fiber such as micron basalt filament or E-glass in a weaving, braiding, or spinning process with the proper epoxy resin, various products can be created that have porous flow paths for fluids along the entire surface area. The pores in the pipes of the wells 103, 105, 107 may be small, to prevent waste in the landfill 100 from entering the pipes. For the carbon dioxide injection wells 107, carbon dioxide 106 is supplied into the wells 107 from an external source, and passes through the pores of the porous pipes of the wells 107 into the landfill 100.

For the pipes of the biogas collection wells 103 and the leachate collection wells 105, the biogas 102 and leachate 104 flow from the landfill 100 into the pipes of the well 103, 105 through the pores of the pipes, and are taken out of the landfill 100. The size of the pipes of the wells 103, 105, 107 may vary and can be determined by the predicted flow of the landfill 100. The exact positioning of the wells 103, 105, 107 can be dependent on or dictated by the shape of the landfill 100. The biogas collection wells 103 are provided at an angle to allow condensate and leachate 104 to enter the landfill 100 for later collection.

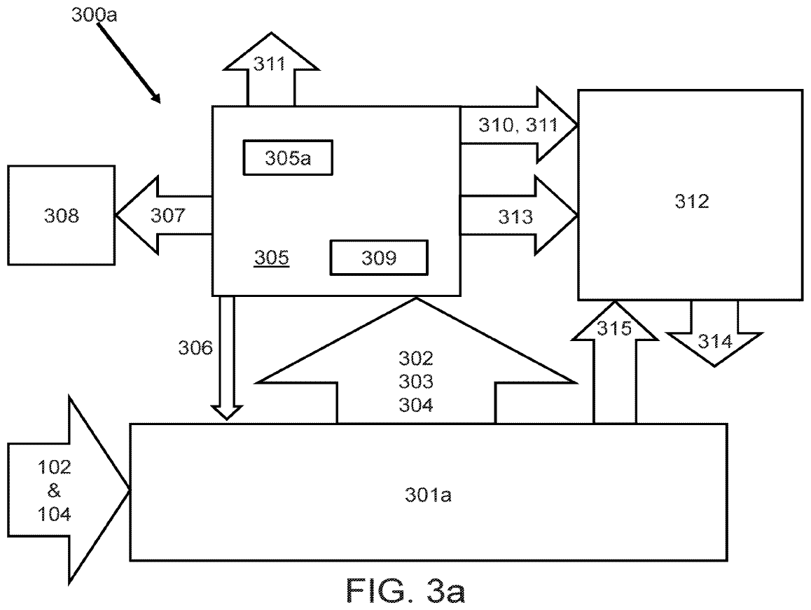

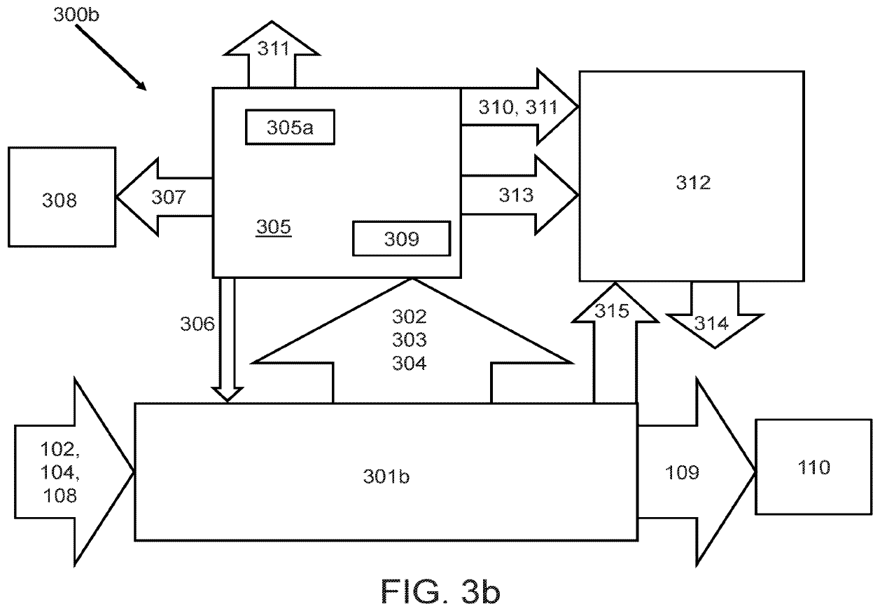

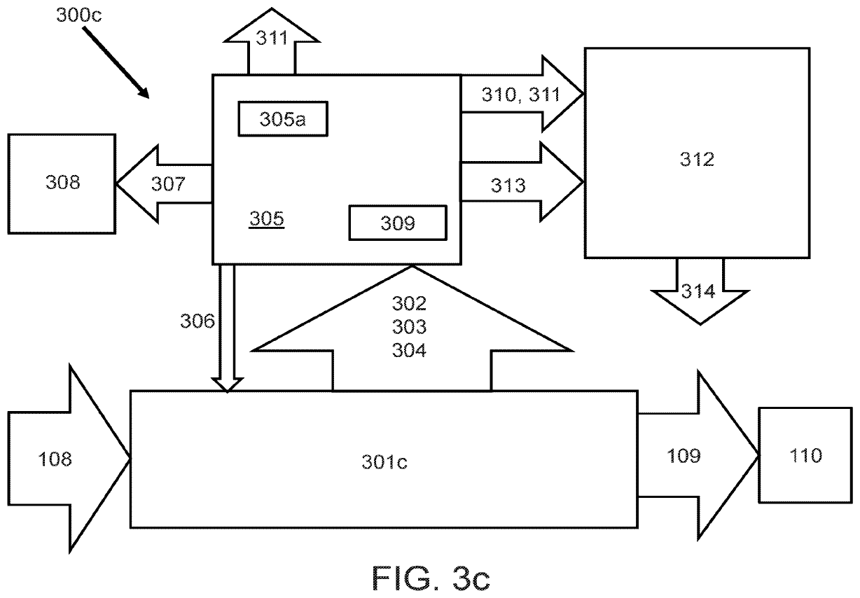

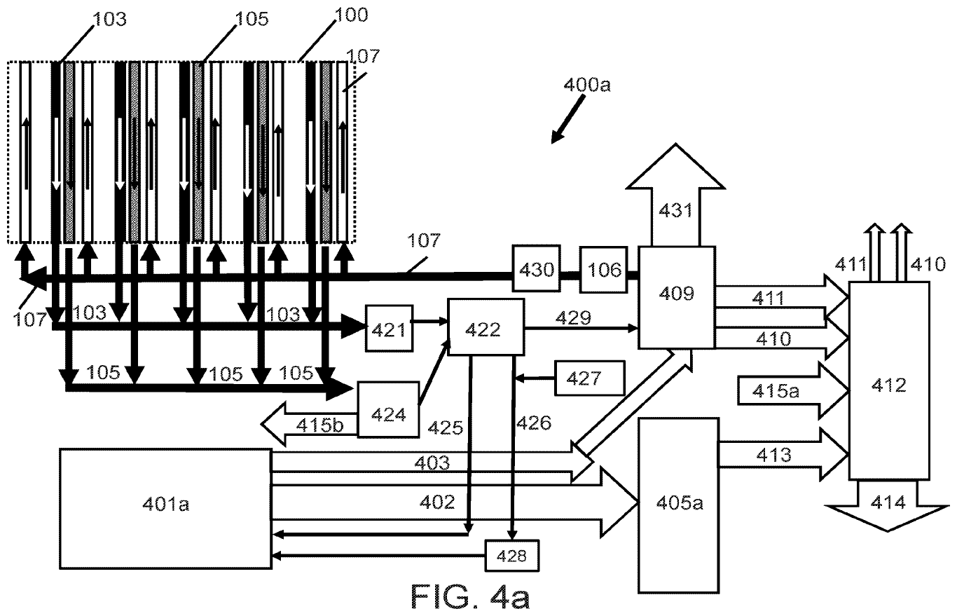

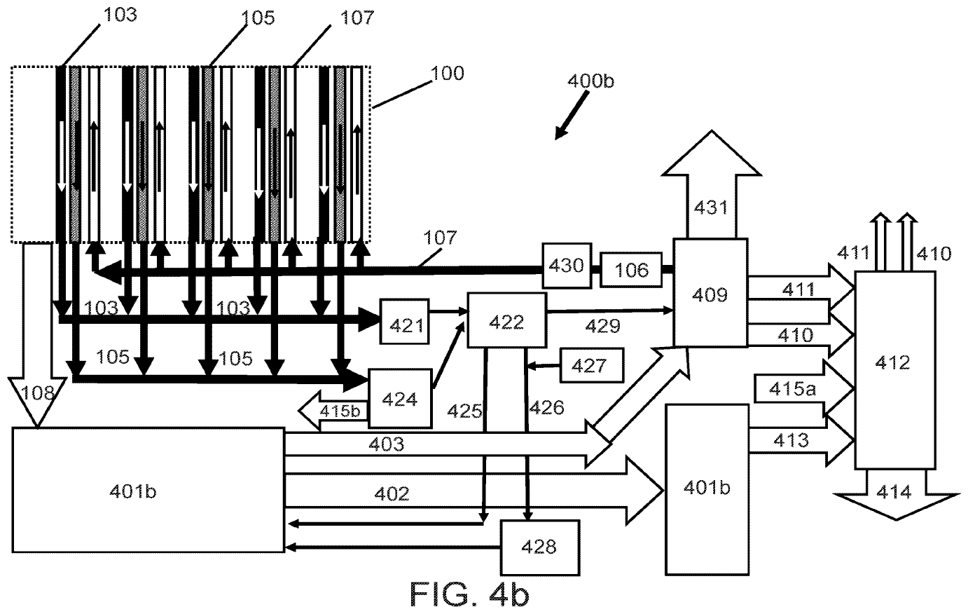

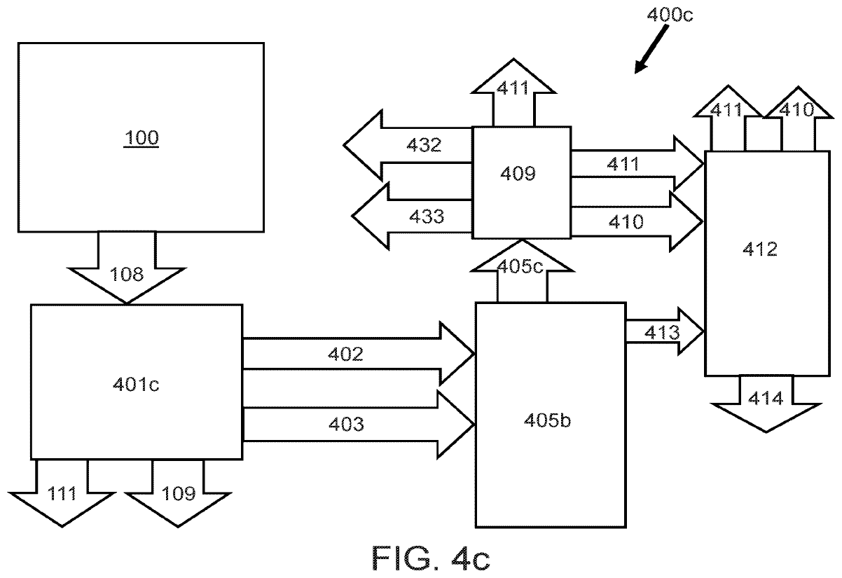

The biogas 102 and the leachate 104 recovered from the landfill 100, as well as the waste 108 of the landfill 100, can be output to further systems for the generation of different forms of energy and the recovery of useful gases for further uses. Examples of such systems are shown in FIGS. 3a-4c and described below.

FIG. 3a shows a diagram of a system 300a for converting methane and leachate into energy in accordance with an embodiment of the present application. A combustion system 301a, comprising a burner, boiler, or furnace, burns methane from the biogas 102, a process which results in the creation of heat 302, exhaust 303, and carbon dioxide 304, which are output to an electricity generation system 305, where the heat 302, exhaust 303, and carbon dioxide 304 are used for electric generation by electric turbines 305a. For example, the heat 302 and heated exhaust 303 may be used to heat a fluid to convert the fluid to steam to power the electric turbines 305a. The electric turbines 305a can be implemented in 5 MW (or larger) modules and are completely expandable, and may be steam or gas turbines. In alternative embodiments not shown in the Figures, the methane recovered from the biogas 102 can be burned directly by electric turbines 305a to generate electricity. The combustion system 301a can be one that is used as part of a separate process, such as a manufacturing process.

The leachate 104 may be used in the digestion of sludge to create humus 315, as described further below in reference to FIG. 4a. The leachate 104 may also be treated to remove contaminants before being provided to the combustion system 301a, and the water in the leachate 104 can then be boiled, resulting in steam that can be included in the exhaust 303.

The combustion system 301a provides low electricity costs, net zero emissions with no carbon dioxide emissions and allows income from converting methane and leachate to electricity generated by an electricity generation system 305 comprising electric turbines 305a. Electricity 306 generated by the electric turbines 305a can be supplied back to the combustion system 301a for powering the components thereof. Electricity 307 generated by the electric turbines 305a can also be supplied back to an electric grid 308.

The system 300a may further comprise a gas separator 309 receiving exhaust gas from the turbines 305a and/or the exhaust 303 from the combustion system 301a. The gas separator 309 is configured to separate component exhaust gases, including carbon dioxide 310, oxygen 314, and nitrogen 311. The carbon dioxide 310 and nitrogen 311 can be delivered to greenhouses 312 and used for crop stimulation (carbon dioxide capture using photosynthesis), or may be delivered to other crop growing environments outside of a greenhouse 312. Carbon dioxide may also be supplied back to the landfill 100 for injection through injection wells 107, as described above. Electricity 313 generated by the electric turbines 305a is also supplied to the greenhouses 312 to meet electric needs of the greenhouses 312. The greenhouses 312 output oxygen 314, and also may receive humus 315 as an input. The greenhouse(s) 312 can be built or provided on top of or adjacent to the landfill 100. The electric turbines 305a can be gas or steam powered.

FIG. 3b shows a diagram of a system 300b for converting recovered methane and leachate, and also recovered landfill waste, into energy in accordance with an embodiment of the present application. In the system 300b, recovered biogas 102 and leachate 104 is supplied as in the system 300a of FIG. 3a, and additionally, the fuel utilized by the system 300b includes waste 108, which may come from refuse, garbage, or trash systems, public or private, including from the same landfill 100 where the biogas 102 and leachate 104 are recovered. Prior to combustion, the waste 108 is sorted to remove metals 111 and plastics 109, so that the waste 108 provided for combustion is only biomass. The plastics 109 can be provided to a separate plastic product manufacturing process 110. A combustion system 301b, comprising a boiler, burner, or furnace, burns methane and waste 108, and provides heat 302, exhaust 303, and carbon dioxide 304 to an electricity generation system 305, where the heat 302, exhaust 303, and carbon dioxide 304 are used for electric generation by electric turbines 305a, as discussed above relating to FIG. 3a. The combustion system 301b can be one that is used as part of a separate process, such as a manufacturing process.

The leachate 104 may be used in the digestion of sludge to create humus 315, as described further below in reference to FIG. 4a. The leachate 104 may also be treated to remove contaminants before being provided to the combustion system 301a, and the water in the leachate 104 can then be boiled, resulting in the generation of steam that can be included in the exhaust 303.

The combustion system 301b provides low electricity costs, net zero emissions with no carbon dioxide emissions and allows income from converting methane and leachate to electricity generated by an electricity generation system 305 comprising electric turbines 305b. Electricity 306 generated by the electric turbines 305b can be supplied back to the waste to energy system for powering the components thereof. Electricity 307 generated by the electric turbines 305a can also be supplied back to an electric grid 308.

The system 300b may further comprise a gas separator 309 receiving exhaust gas from the turbines 305a and/or the exhaust 303 from the combustion system 301b. The gas separator 309 is configured to separate component exhaust gases, including carbon dioxide 310, oxygen 314, and nitrogen 311. The carbon dioxide 310 and nitrogen 311 can be delivered to greenhouses 312 and used for crop stimulation (carbon dioxide capture using photosynthesis), or may be delivered to other crop growing environments outside of a greenhouse 312. Carbon dioxide may also be supplied back to the landfill 100 for injection through injection wells 107, as described above. Electricity 313 generated by the electric turbines 305a is also supplied to the greenhouses 312 to meet electric needs of the greenhouses 312. The greenhouses 312 output oxygen 314, and also may receive humus 315 as an input. The greenhouse(s) 312 can be built or provided on top of or adjacent to the landfill 100. The electric turbines 305a can be gas or steam powered.

FIG. 3c shows a diagram of a system 300c for converting waste into energy in accordance with an embodiment of the present application. In the system 300c, the fuel utilized by the system 300c includes waste 108 (i.e., biomass recovered from refuse garbage), as described above, but excluding biogas 102 and leachate 104. Prior to combustion, the waste 108 is sorted to remove metals 111 and plastics 109, so that the waste 108 provided for combustion is only biomass. The plastics 109 can be provided to a separate plastic product manufacturing process 110. A combustion system 301c, comprising a burner, boiler or furnace, burns waste 108, and provides heat 302, exhaust 303, and carbon dioxide 304 to an electricity generation system 305, where the heat 302, exhaust 303, and carbon dioxide 304 are used for electric generation by electric turbines 305a. The combustion system 301c can be one that is used as part of a separate process, such as a manufacturing process. Electricity 306 generated by the electric turbines 305b can be supplied back to the waste to energy system for powering the components thereof. Electricity 307 generated by the electric turbines 305a can also be supplied back to an electric grid 308.

The system 300c may further comprise a gas separator 309 receiving exhaust gas from the turbines 305a and/or the exhaust 303 from the combustion system 301c. The gas separator 309 is configured to separate component exhaust gases, including carbon dioxide 310, oxygen 314, and nitrogen 311. The carbon dioxide 310 and nitrogen 311 can be delivered to greenhouses 312 and used for crop stimulation (carbon dioxide capture using photosynthesis), or may be delivered to other crop growing environments outside of a greenhouse 312. Carbon dioxide may also be supplied back to the landfill 100 for injection through injection wells 107, as described above. Electricity 313 generated by the electric turbines 305a is also supplied to the greenhouses 312 to meet electric needs of the greenhouses 312. The greenhouse(s) 312 can be built or provided on top of or adjacent to the landfill 100. The electric turbines 305a can be gas or steam powered.

FIG. 4a shows a diagram of a methane processing system 400a in accordance with an embodiment of the present application. A pump 421 draws in biogas 102 in the landfill 100 into the biogas collection wells 103, as shown and described in reference to FIGS. 1a-1b, and pumps the biogas 102 to a gas separator 422. The gas separator 422 separates out component gases of the collected biogas 102, include methane, oxygen, and carbon dioxide. The separated oxygen 425 and methane 426 are delivered to the combustion system 401 a to generate steam 402 for the electric turbines 405a. The electric turbines 405a can be gas powered or steam powered, and supply the necessary electricity for the components of the system 400a. The combustion system 401a comprises a boiler, burner, or furnace, as previously described in reference to FIGS. 3a-3c. Any condensate is removed, and the hot exhaust 403 is also used in the generation of steam 402, and then delivered to the second gas separator 409. For example, the heated exhaust 403 may transfer heat to a fluid such as water, in the combustion system 401a to generate additional steam 402, and the cooled exhaust is supplied to the gas separator 409. Natural gas 427 can be used to supplement the flow of methane 426 from the landfill 100 if needed to support the combustion system 401a. If the landfill 100 produces more methane than is required for the combustion system 401a, the methane 426 may be stored in a methane storage 428. The exhaust and other gases 429 from the gas separator 422 are delivered to another gas separator 409.

The leachate 104 is provided from the landfill 100 by the leachate collection wells 105 to a sludge digester 424. As discussed in applicant's International Patent Application PCT/US22/81571 filed Dec. 14, 2022, which is hereby incorporated by reference, as wastewater is processed to remove larger contaminants, sludge results comprising smaller solids and contaminants in water that is to be treated for recycling. Wastewater treatment systems comprise steps for solids processing may include components such as a sludge thickener system, a digester system, a sludge dewatering system, and a grid washing and dewatering system. Sludge digesters are large, heated mechanical devices in which anaerobic microorganisms break down the sludge solids into stable compounds. Leachate 104 can be a rich source of such anaerobic microbes that can be used to digest and breakdown the solids in sludge. In the system 400a of FIG. 4a, the leachate 104 is provided to a sludge digester 424 receiving sludge (not shown) from a wastewater treatment system, and the microbes of the leachate 104 are used by the sludge digester 424. The sludge digester 424, digests the sludge, and provides it to one or more belt presses configured to press out liquid remaining in the digested sludge or other drying device. The final processed and dried sludge can result in humus 415a, 415b, that can be provided to greenhouses 412 for crop growth. Methane recovered from the sludge digester 424 can be provided to the gas separator 422.

The gas separator 409 separates the carbon dioxide 106 from the supplied gases 429 and exhaust 403 and outputs the carbon dioxide 106 to a pump 430, which pumps the carbon dioxide into the injection wells 107 for the landfill 100. The gas separator 409 also separates the nitrogen 411 and delivers it to the greenhouses 412, along with additional carbon dioxide 410, and releases or processes the other gases 431. The greenhouses 412 use as much carbon dioxide 410 and nitrogen 411 as needed, and release oxygen 414. Excess carbon dioxide 410 and nitrogen 411 can be sold or released. The greenhouses are supplied with electricity 413 from the electric turbines 405a.

If there are enough greenhouses 412, an effective negative net emissions of the greenhouse gas can be achieved because of the elimination of the methane. The total greenhouse gas emissions of the system are the carbon dioxide generated from burning methane and gas plus the carbon dioxide extracted or released from the landfill, less the carbon dioxide injected into landfill and the carbon dioxide used by greenhouses, and also less the methane recovered from the landfill (noting that methane can be 28 to 36 times more effective than carbon dioxide at trapping heat).

FIG. 4b shows a diagram of methane and waste processing system 400b in accordance with an embodiment of the present application. A pump 421 draws in biogas 102 in the landfill 100 into the biogas collection wells 103, as shown and described in reference to FIGS. 1a-1b, and pumps the biogas 102 to a gas separator 422. The gas separator 422 separates out component gases of the collected biogas 102, include methane, oxygen, and carbon dioxide. The separated oxygen 425 and methane 426 are delivered to the combustion system 401a to generate steam 402 for the electric turbines 405a. The electric turbines 405a can be gas powered or steam powered, and supply the necessary electricity for the components of the system 400a. The combustion system 401a comprises a boiler, burner, or furnace, as previously described in reference to FIGS. 3a-3c. The waste 108 is sorted and separated, and the metals 111 and plastics 109 are removed. The remaining waste 108 is burned to create steam 402. Any condensate is removed, and the hot exhaust 403 is also used in the generation of steam 402, and then delivered to another gas separator 409. For example, the heated exhaust 403 may transfer heat to a fluid such as water, in the combustion system 401a to generate additional steam 402, and the cooled exhaust is supplied to the gas separator 409. Natural gas 427 can be used to supplement the flow of methane 426 from the landfill 100 if needed to support the combustion system 401a. If the landfill 100 produces more methane than is required for the combustion system 401a, the methane 426 may be stored in a methane storage 428. The exhaust and other gases 429 from the gas separator 422 are delivered to another gas separator 409.

In the system 400b of FIG. 4b, the leachate 104 is provided to a sludge digester 424 receiving sludge (not shown) from a wastewater treatment system, and the microbes of the leachate 104 are used by the sludge digester 424. The sludge digester 424, digests the sludge, and provides it to one or more belt presses configured to press out liquid remaining in the digested sludge or other drying device. The final processed and dried sludge can result in humus 415a, 415b, that can be provided to greenhouses 412 for crop growth. Methane recovered from the sludge digester 424 can be provided to the gas separator 422.

The exhaust 403 from the burning of the methane and waste 108, and other gases 429 from the gas separator 422, are delivered to another gas separator 409. The gas separator 409 separates the carbon dioxide 106 from the supplied gases 429 and exhaust 403 and outputs the carbon dioxide 106 to a pump 430, which pumps the carbon dioxide into the injection wells 107 for the landfill 100. The gas separator 409 also separates the nitrogen 411 and delivers it to the greenhouses 412, along with additional carbon dioxide 410, and releases or processes the other gases 431. The greenhouses 412 use as much carbon dioxide 410 and nitrogen 411 as needed, and release oxygen 414. The excess carbon dioxide 410 and nitrogen 411 can be sold or released. The greenhouses are supplied with electricity 413 from the electric turbines 405a.

If there are enough greenhouses 412, an effective negative net emissions of the greenhouse gas can be achieved because of the elimination of the methane. The total greenhouse gas emissions of the system are the carbon dioxide generated from burning waste, methane, and gas plus the carbon dioxide extracted or released from the landfill, less the carbon dioxide injected into landfill and the carbon dioxide used by greenhouses, and also less the methane recovered from the landfill (noting that methane can be 28 to 36 times more effective than carbon dioxide at trapping heat). The metals 111 can be sold and the plastic 109 used for products and the land is reclaimed.

FIG. 4c shows a diagram of a further waste processing system 400c in accordance with an embodiment of the present application. The waste 108 is sorted and separated, and the metals 111 and plastics 109 are removed. The remaining waste 108 is burned to create steam 402. Natural gas can be used to supplement the varying btu content of the waste 108. The exhaust 403 from the burning of the waste 108 is delivered to a gas separator 409. The electric turbines 405b power all the necessary electricity for the system 400c. The separator 409 separates the carbon dioxide 410 and delivers it to the greenhouses 412, separates the nitrogen 411 and delivers it to the greenhouses 412, and releases or processes the other gases including hydrogen 432 or oxygen 433. The greenhouses 412 use as much carbon dioxide 410 and nitrogen 411 as needed and the excess is sold or released. If there are enough greenhouses 412, an effective net neutral emission can be achieved. The total greenhouse gas emissions of the system are the carbon dioxide generated from burning waste less the carbon dioxide used by greenhouses.

Although the present application describes the system in reference to landfills, it is noted that the systems and methods described herein other waste or refuse repository storage systems other than landfills.

It should be understood that, unless stated otherwise herein, any of the features, characteristics, alternatives or modifications described regarding a particular embodiment herein may also be applied, used, or incorporated with any other embodiment described herein. Also, the Figures herein are not drawn to scale. Although the invention has been described and illustrated with respect to exemplary embodiments thereof, the foregoing and various other additions and omissions may be made therein and thereto without departing from the spirit and scope of the present invention.

What is claimed:

1. A system comprising:
a waste repository comprising waste therein;
one or more biogas collection wells configured to collect biogas in the waste repository, the biogas comprising methane;
one or more leachate collection wells configured to collect leachate in the waste repository, the leachate comprising water; and
one or more carbon dioxide injection wells configured to inject carbon dioxide into the waste repository;
wherein the one or more biogas collection wells, the one or more leachate collection wells, and the one or more carbon dioxide injection wells are arranged in a stratification in the waste repository wherein the one or more biogas collection wells are arranged on top of the one or more leachate collection wells, and the one or more leachate collection wells are arranged on top of the one or more carbon dioxide injection wells.

2. The system according to claim 1, wherein the waste repository is a landfill.

3. The system according to claim 2, further comprising one or more carbon dioxide pumps configured to pump the carbon dioxide into the one or more carbon dioxide injection wells, wherein carbon dioxide injected into the landfill is pressurized and configured to push the biogas in the landfill towards an upper stratum of the landfill.

4. The system according to claim 3, further comprising one or more biogas pumps configured to pull the biogas into the one or more biogas collection wells.

5. The system according to claim 4, further comprising one or more leachate pumps configured to pull the leachate into the one or more leachate collection wells.

6. The system according to claim 5, wherein each of the one or more biogas collection wells, the one or more leachate collection wells, and the one or more carbon dioxide injection wells comprise porous pipes within the landfill, the porous pipes comprising a pipe with pores through pipe walls to allow a gas or liquid to pass through the pipe walls into or out of the pipe.

7. The system according to claim 6, wherein the porous pipes of the one or more biogas collection wells, the one or more leachate collection wells, and the one or more carbon dioxide injection wells are arranged horizontally across the landfill.

8. The system according to any of the preceding claims, further comprising a first gas separator configured to:
receive the biogas collected from the landfill;
separate component gases of the biogas; and
output separated gases, including separated methane.

9. The system according to claim 8, further comprising an external combustion system configured to receive and burn the separated methane to provide thermal energy for powering one or more turbines of an electricity generating system.

10. The system according to claim 9, wherein the external combustion system is further configured to provide heated exhaust gas to the one or more turbines.

11. The system according to claim 10, wherein the electricity generation system is configured to provide electricity for powering electrical components of the system.

12. The system according to claim 11, wherein the electricity generation system is further configured to provide electricity to a grid or an external facility consuming the electricity.

13. The system according to claim 12, further comprising a second gas separator configured to receive turbine exhaust gases and to separate carbon dioxide from the turbine exhaust gases and provide at least a portion of the separated carbon dioxide to the one or more carbon dioxide injection wells configured to inject the separated carbon dioxide into the landfill.

14. The system according to claim 13, further comprising:
a crop or plant growth system, wherein the electricity generation system is further configured to provide electricity to the crop or plant growth system.

15. The system according to claim 14, wherein the second gas separator is configured to: separate oxygen gas, carbon dioxide gas, and nitrogen gas from the turbine exhaust gases and other gases provided to the second gas separator; and provide at least a portion of the separated carbon dioxide gas and separated nitrogen gas to the crop or plant growth system for stimulation of crop or plant growth.

16. The system according to claim 15, further comprising a sludge digester configured to receive the leachate collected in the landfill from the one or more leachate collection wells and to receive sludge from a wastewater treatment system, wherein the leachate comprises microorganisms for digesting the sludge in the sludge digester, and
wherein sludge digester is configured to output a fertilizing material for providing to the crop or plant growth system and output gases to the first gas separator.

17. The system according to claim 16, wherein the external combustion system further comprises a furnace or burner configured to combust biomass waste from the landfill and is configured to provide thermal energy from biomass waste combustion to the one or more turbines for heating fluid to generate steam for the one or more turbines.

18. The system according to claim 17, wherein the biomass waste combustion further provides heated waste exhaust gases to the one or more turbines for heating fluid to generate steam for the one or more turbines.

19. The system according to claim 9, wherein the external combustion system further comprises a furnace or burner configured to combust biomass waste from the landfill and is configured to provide thermal energy from biomass waste combustion to the one or more turbines for heating fluid to generate steam for the one or more turbines.

20. The system according to claim 19, wherein the biomass waste combustion further provides heated waste exhaust gases to the one or more turbines for heating fluid to generate steam for the one or more turbines.

21. A method for processing gases in a landfill having waste therein, comprising:
collecting biogas in the landfill by one or more biogas collection wells, the biogas comprising methane;
collecting leachate in the landfill by one or more leachate collection wells, the leachate comprising water; and
injecting carbon dioxide into the landfill by one or more carbon dioxide injection wells;
wherein the one or more biogas collection wells, the one or more leachate collection wells, and the one or more carbon dioxide injection wells are arranged in a stratification in the landfill wherein the one or more biogas collection wells are arranged on top of the one or more leachate collection wells, and the one or more leachate collection wells are arranged on top of the one or more carbon dioxide injection wells.

22. The method according to claim 21, further comprising pumping, by one or more carbon dioxide pumps, carbon dioxide into the one or more carbon dioxide injection wells.

23. The method according to claim 22, wherein injecting carbon dioxide into the landfill by one or more carbon dioxide injection comprises injecting pressurized carbon dioxide into the landfill, the pressurized carbon dioxide configured to push the biogas in the landfill towards an upper stratum of the landfill.

24. The method according to claim 23, further comprising pulling the biogas into the one or more biogas collection wells by one or more biogas pumps.

25. The method according to claim 24, further comprising pulling the leachate into the one or more leachate collection wells by one or more leachate pumps.

26. The method according to claim 25, wherein each of the one or more biogas collection wells, the one or more leachate collection wells, and the one or more carbon dioxide injection wells comprise porous pipes within the landfill, the porous pipes comprising a pipe with pores through pipe walls to allow a gas or liquid to pass through the pipe walls into or out of the pipe.

27. The method according to claim 26, wherein the porous pipes of the one or more biogas collection wells, the one or more leachate collection wells, and the one or more carbon dioxide injection wells are arranged horizontally across the landfill.

28. The method according to any of claims 21-27, further comprising:
receiving, by a first gas separator, the biogas collected from the landfill;
separating, by the first gas separator, component gases of the biogas; and
outputting, by the first gas separator, separated gases, including separated methane.

29. The method according to claim 28, further comprising: burning the separated methane in an external combustion system, and providing thermal energy from the external combustion system for powering one or more turbines of an electricity generating system.

30. The method according to claim 29, further comprising providing heated exhaust gas from the external combustion system to the one or more turbines.

31. The method according to claim 30, wherein the electricity generation system is configured to provide electricity for powering electrical components of the system.

32. The method according to claim 31, wherein the electricity generation system is further configured to provide electricity to a grid or an external facility consuming the electricity.

33. The method according to claim 32, further comprising:
receiving, by a second gas separator, turbine exhaust gases;
separating, by the second gas separator, carbon dioxide from the turbine exhaust gases; and
providing, by the second gas separator, at least a portion of the separated carbon dioxide to the one or more carbon dioxide injection wells injecting the separated carbon dioxide into the landfill.

34. The method according to claim 33, further comprising: providing electricity from the electricity generation system to a crop or plant growth system.

35. The method according to claim 34, further comprising:
separating, by the second gas separator, oxygen gas, carbon dioxide gas, and nitrogen gas from the turbine exhaust gases and other gases provided to the second gas separator; and
providing, from the second gas separator, at least a portion of the separated carbon dioxide gas and separated nitrogen gas to the crop or plant growth system for stimulation of crop or plant growth.

36. The method according to claim 35, further comprising:
providing the leachate collected in the landfill from the one or more leachate collection wells and sludge from a wastewater treatment system to a sludge digester;
digesting the sludge by the sludge digester, and
outputting a fertilizing material for providing to the crop or plant growth system and outputting gases to the first gas separator, from the sludge digester.

37. The method according to claim 36, further comprising:
providing biomass waste from the landfill to the external combustion system;
burning the biomass waste by a furnace or burner of the external combustion system; and
providing thermal energy from biomass waste combustion to the one or more turbines for heating fluid to generate steam for the one or more turbines.

38. The method according to claim 37, further comprising providing heated waste exhaust gases from the biomass waste combustion to the one or more turbines for heating fluid to generate steam for the one or more turbines.

39. The method according to claim 29, further comprising:
providing biomass waste from the landfill to the external combustion system;
burning the biomass waste by a furnace or burner of the external combustion system; and
providing thermal energy from biomass waste combustion to the one or more turbines for heating fluid to generate steam for the one or more turbines.

40. The method according to claim 39, further comprising providing heated waste exhaust gases from the biomass waste combustion to the one or more turbines for heating fluid to generate steam for the one or more turbines.
